(19) United States
(12) Patent Application Publication
(10) Pub. No.: US 2017/0059303 A1
(43) Pub. Date: Mar. 2, 2017

(54) NONDESTRUCTIVE OPTICAL DETECTION OF TRACE UNDERCUT, WIDTH AND THICKNESS

(71) Applicants: Robert Alan May, Chandler, AZ (US); Sri Ranga Sai Boyapati, Chandler, AZ (US); Zhiyong Wang, Chandler, AZ (US); Shuhong Liu, Chandler, AZ (US); Pilin Liu, Chandler, AZ (US)

(72) Inventors: Robert Alan May, Chandler, AZ (US); Sri Ranga Sai Boyapati, Chandler, AZ (US); Zhiyong Wang, Chandler, AZ (US); Shuhong Liu, Chandler, AZ (US); Pilin Liu, Chandler, AZ (US)

(21) Appl. No.: 14/840,883

(22) Filed: Aug. 31, 2015

(51) Int. Cl. G01B 11/06

(52) U.S. Cl. CPC G01B 11/0616

(57) ABSTRACT

Some example forms relate to a method of nondestructively measuring a geometry of an electrical component on a substrate. The method includes directing light at the electrical component. The light is at an original intensity. The method further includes measuring light that is reflected off of the electrical component. The reflected light includes undiffracted light and diffracted light. The diffracted light is at a diffracted intensity. The method further includes determining a ratio of diffracted intensity to original intensity and utilizing the ratio to determine a geometry of the electrical component.

### BACKGROUND

Semi Additive Process (SAP) is a manufacturing technique commonly used for printed circuit boards (PCBs) and substrates for integrated circuits. During an SAP a buildup dielectric layer is commonly metallized with a layer of electroless copper to support subsequent patterned electrodeposition of copper. This buildup layer of electroless copper is then lithographically patterned. The patterned copper layer is applied to the layer of electroless copper using electroplating techniques.

Once the patterned copper layer is applied to the layer of electroless copper, the electroless copper must be removed (e.g., by flash etching or quick etching) to prevent shorting of the patterned copper traces. Etching the electroless copper from the dielectric layer often results in trace “undercut” beneath the patterned copper traces.

This undercut beneath the patterned copper trace typically leads to issues with trace lifting and reliability. Therefore, minimizing or eliminating undercut beneath the patterned copper traces may be crucial to a superior high volume manufacturing (HVM) process.

Unfortunately, the conventional methods for measuring trace undercut undesirably destroys manufactured components by cross-sectioning the components in order to check trace undercut. This conventional process for measuring trace undercut is both destructive and time consuming.

### BRIEF DESCRIPTION OF THE DRAWINGS

FIG. 1 shows that a generated diffraction pattern is sensitive to the amount of undercut.

FIG. 2 shows that the sensitivity to this undercut depends on the angle of incidence of the incoming light making it possible to decouple the undercut from variation in trace width and thickness.

FIG. 3 shows the dependence of diffraction efficiency (DE) on the angle of incidence of incoming light.

FIG. 4 is a flow diagram illustrating an example method of nondestructively measuring an undercut on an electrical trace.

FIG. 5 is schematic view illustrating the method of nondestructively measuring an undercut on an electrical trace shown in FIG. 4.

FIG. 6 is a flow diagram illustrating an example method of nondestructively measuring electrical trace geometry.

FIG. 7 is schematic view illustrating the method of nondestructively measuring electrical trace geometry shown in FIG. 6.

FIG. 8 is a flow diagram illustrating an example method of nondestructively measuring a geometry of an electrical component on a substrate.

FIG. 9 is schematic view illustrating the method of nondestructively measuring a geometry of an electrical component on a substrate shown in FIG. 8.

FIG. 10 is block diagram of an electronic apparatus that includes the methods described herein.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Orientation terminology, such as “horizontal,” as used in this application is defined with respect to a plane parallel to the conventional plane or surface of a wafer or substrate, regardless of the orientation of the wafer or substrate. The term “vertical” refers to a direction perpendicular to the horizontal as defined above. Prepositions, such as “on,” “side” (as in “sidewall”), “higher,” “lower,” “over,” and “under” are defined with respect to the conventional plane or surface being on the top surface of the wafer or substrate, regardless of the orientation of the electrical interconnect or electronic package.

The methods described herein may provide a non-destructive optical method of measuring trace pitch, width and undercut that improves high volume manufacturing. In addition, methods may be used to measure a geometry of any electrical component on a substrate.

Diffraction occurs when waves constructively and destructively interfere with one another causing a pattern to emerge. This phenomenon is observed as rainbows in the sky, holograms protecting credit cards and in the patterned reflection of a laser pointer on the back of a compact disc (CD). The way that light diffracts from a textured surface tells us about the size, shape and composition of the textured surface.

Copper features on substrates tend to be formed into patterns that are conducive to the formation of a strong diffraction pattern using visible light. This diffraction pattern will vary with the trace thickness, width and shape.

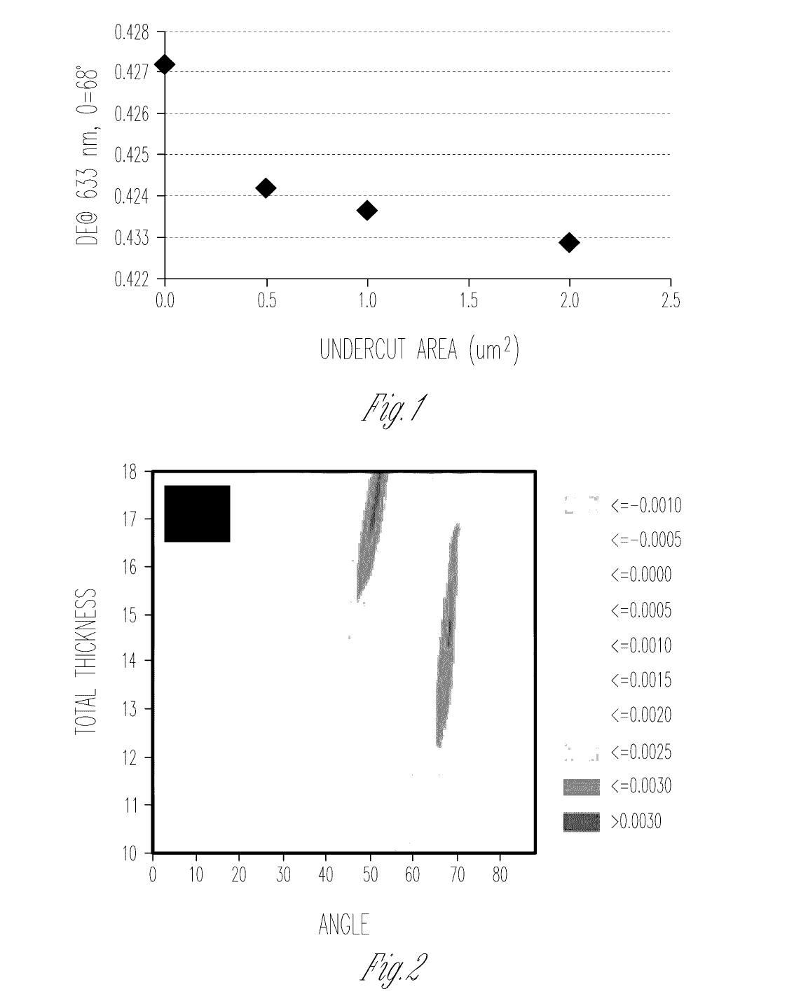

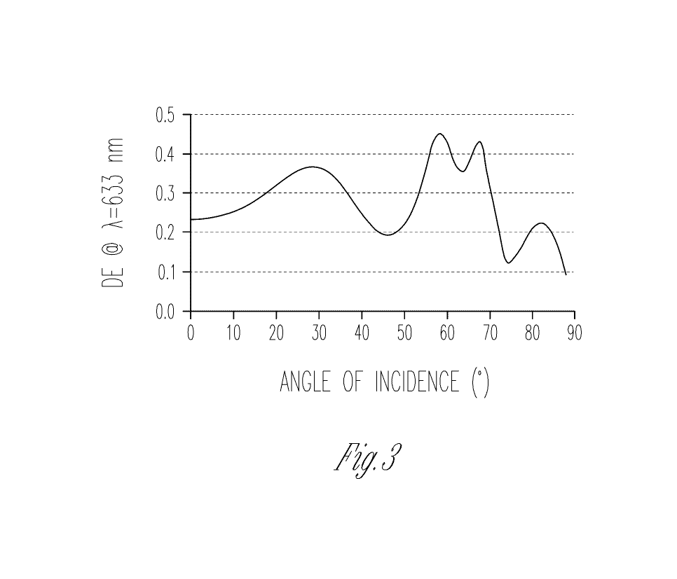

FIG. 1 shows that the diffraction pattern is sensitive to the amount of undercut trace. FIG. 2 shows that the sensitivity to this undercut depends on the angle of incidence of the incoming light which may make it possible to decouple the undercut from variation in trace width and thickness. This phenomenon may be used to quickly and non-destructively characterize trace undercut, which provides a significant improvement over conventional destructive and time consuming processes (i.e., cross sectioning an electronic component.

Diffraction based sensing may readily be integrated into existing microscope setups. As an example, a Bertrand lens may be inserted into the light path to image the rear focal plane. The Bertrand lens may produce an image of the diffraction pattern which can then be quantified using a charge coupled device (CCD). The CCD may capture all diffracted spots simultaneously thereby eliminating issues with source and detector fluctuation and allowing for sensitive and accurate detection of diffraction.

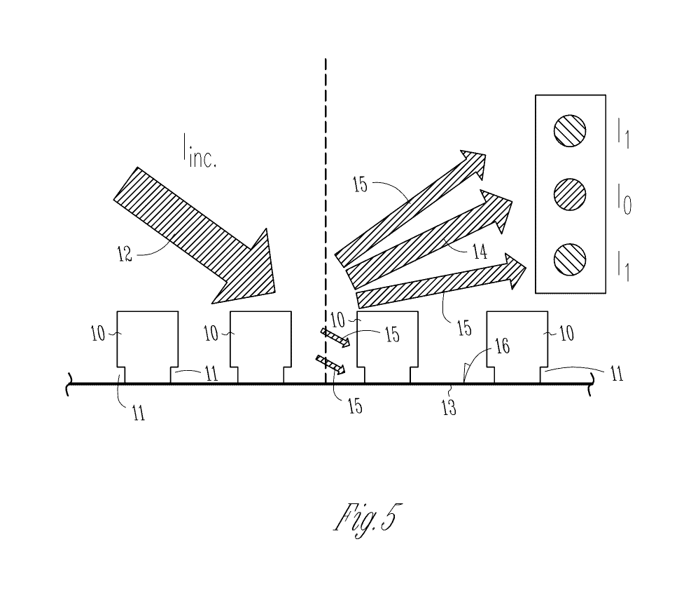

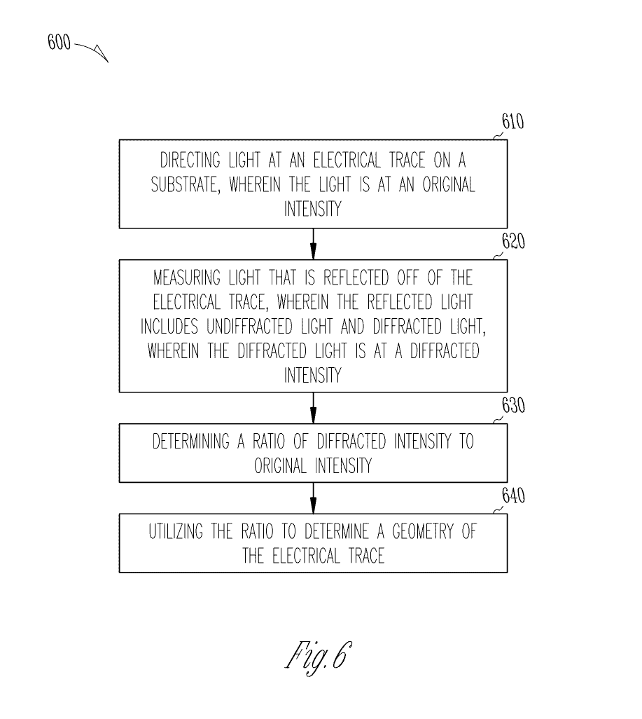

FIGS. 4-5 illustrate an example detection scheme for diffraction based sensing of trace undercuts. Light reflects from a periodic array of traces (e.g., serp and comb structures) and undergoes constructive and destructive interference to form a pattern. Undiffracted light is shown as I₀ while diffracted light is L. It would be noted there would be many additional diffracted spots but they have significantly diminished intensity. This diffraction is quantified using a figure of merit known as diffraction efficiency

$$( DE ) which = \frac{\sum {I}_{Diff .}}{{I}_{Inc .}}$$

Therefore, DE is the sum of the intensity of the diffracted light divided by the intensity of the incoming light. In some forms, separation between the spots of the diffraction pattern is dependent upon pitch and may be used to determine trace width.

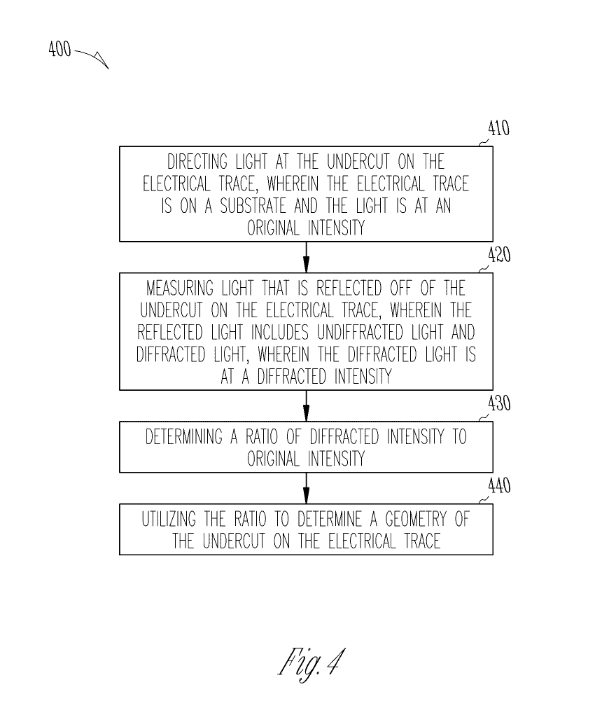

FIG. 3 shows the dependence of DE on the angle of incidence of the incoming light. The actual sensitivity to undercut may be highly angle dependent. Therefore, some angles may be used to determine trace width and thickness while other angles may be used to determine trace undercut.

As an example, when the angle of incidence is below ˜25° there is almost no sensitivity to the undercut and the difference in response is ˜0. However, DE in this region is still sensitive to trace width and thickness, so that these angles may be used to determine these parameters. In addition, the information that is retrieved at lower angles (e.g., 15° to 30°) may be combined with DE from larger angles of incidence to determine the magnitude of the trace undercut.

Changes in DE with undercut area (fixed height of 1 um, varying length) at θ=68° is shown in FIG. 1. Changes in DE are subtle but may be detected because the light intensity is detected simultaneously in order to reduce temporal source variations. In addition, multiple angles may give additional data for fitting and using multiple wavelengths would provide even more confidence in the data.

FIG. 4 is a flow diagram illustrating an example method [400] of nondestructively measuring an undercut 11 on an electrical trace 10. FIG. 5 is schematic view illustrating the method [400] of nondestructively measuring an undercut 11 on an electrical trace 10 shown in FIG. 4.

The method [400] includes [410] directing light 12 at the undercut 11 on the electrical trace 10. The electrical trace 10 is on a substrate 13 and the light 12 is at an original intensity I_{inc}.

The method [400] further includes [420] measuring light that is reflected off of the undercut 11 on the electrical trace 10. The reflected light includes undiffracted light 14 and diffracted light 15. The diffracted light 15 is at a diffracted intensity I₁.

The method [400] further includes [430] determining a ratio of diffracted intensity I₁ to original intensity I₁ and [440] utilizing the ratio to determine a geometry of the undercut 11 on the electrical trace 10. As an example, [440] utilizing the ratio to determine a geometry of the undercut 11 on the electrical trace 10 includes utilizing the ratio to determine a volume of the undercut 11 on the electrical trace 10.

In some forms, [440] utilizing the ratio to determine a geometry of the undercut 11 on the electrical trace 10 may include (i) comparing the ratio with a stored set of data; and/or (ii) determining the geometry by performing mathematical calculations using the ratio. In addition, [430] directing light 12 at the undercut 11 on the electrical trace 10 includes directing light 12 at (i) an angle between 50 and 70 degrees relative to an upper surface 16 of the substrate 13; and/or (ii) multiple angles relative to an upper surface 16 of the substrate 13.

In some forms, [420] measuring light that is reflected off of the undercut 11 on the electrical trace 10 may include measuring light with a CCD array. It should be noted that other forms of [420] measuring light that is reflected off of the undercut 11 on the electrical trace 10 are contemplated.

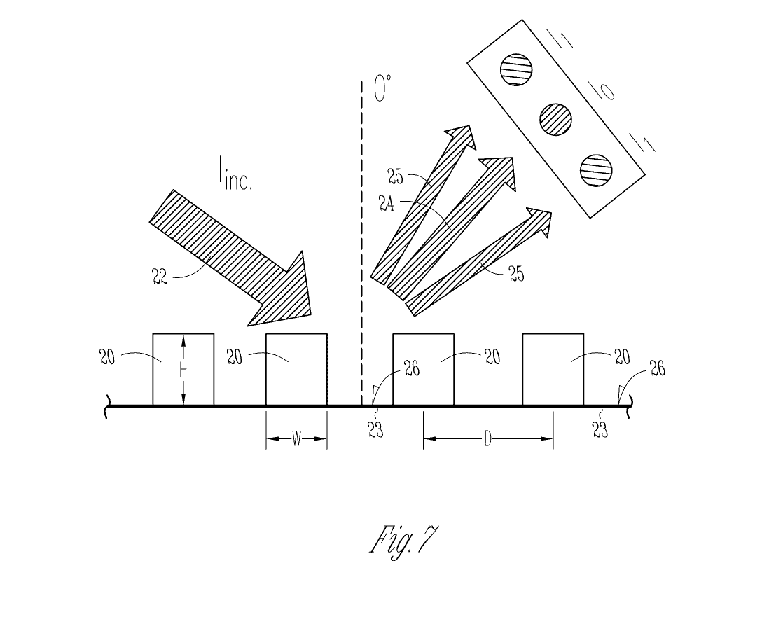

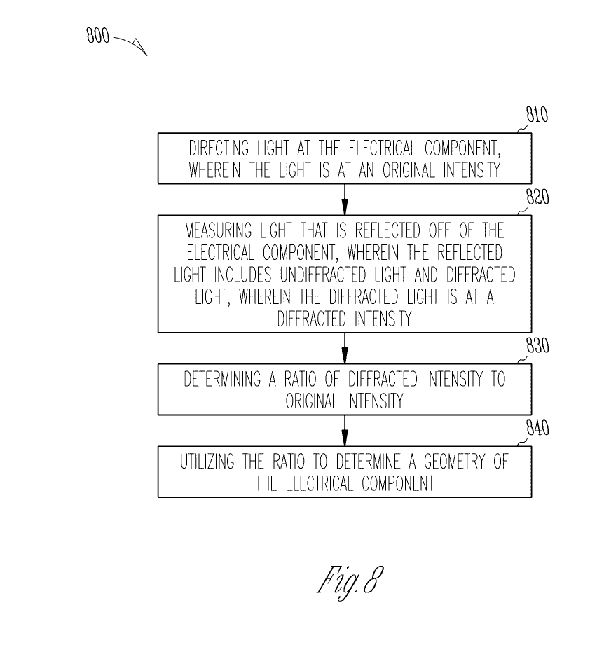

FIG. 6 is a flow diagram illustrating an example method [600] of nondestructively measuring electrical trace 20 geometry. FIG. 7 is a schematic view illustrating the method [600] of nondestructively measuring electrical trace geometry shown in FIG. 6.

The method [600] includes [610] directing light 22 at an electrical trace 20. The electrical trace 20 is on a substrate 23 and the light 22 is at an original intensity I_{inc}.

The method [600] further includes [620] measuring light that is reflected off of the electrical trace 20. The reflected light includes undiffracted light 24 and diffracted light 25. The diffracted light 25 is at a diffracted intensity I₁.

The method [600] further includes [630] determining a ratio of diffracted intensity I₁ to original intensity I_{inc} and [640] utilizing the ratio to determine a geometry of the electrical trace 20. As an example, [640] utilizing the ratio to determine a geometry of the electrical trace 20 includes utilizing the ratio to determine a height H and a width W of the electrical trace 20.

In some forms, [640] utilizing the ratio to determine a geometry of the electrical trace 20 may include (i) comparing the ratio with a stored set of data; and/or (ii) performing mathematical calculations using the ratio. In addition, [630] directing light 22 the electrical trace 20 includes directing light 22 at (i) an angle between 15 and 30 degrees relative to an upper surface 26 of the substrate 23; and/or (ii) multiple angles relative to an upper surface 26 of the substrate 23.

In some forms, [620] measuring light that is reflected off of the electrical trace 20 may include measuring light with a CCD array. It should be noted that other forms of [620] measuring light that is reflected off of the electrical trace 20 are contemplated.

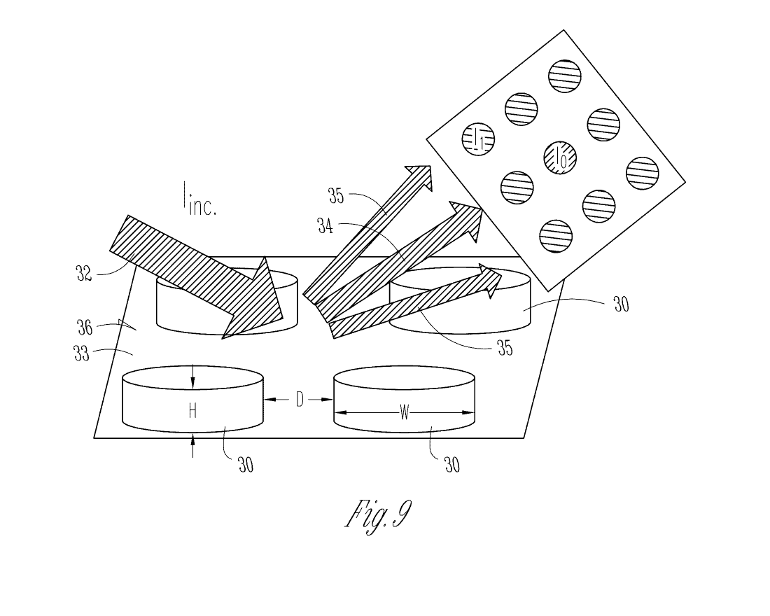

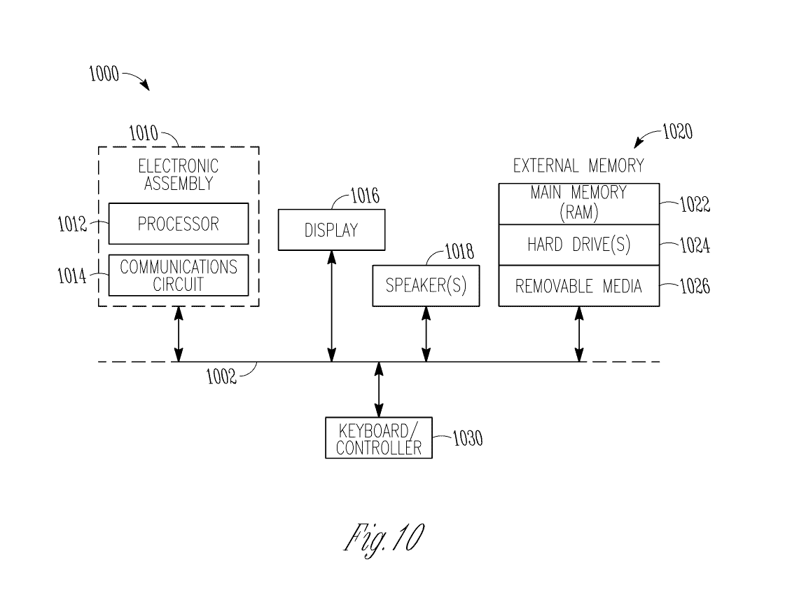

FIG. 8 is a flow diagram illustrating an example method [800] of nondestructively measuring a geometry of an electrical component 30 on a substrate 33. FIG. 9 is schematic view illustrating the method of nondestructively measuring a geometry of an electrical component 30 on a substrate 33 shown in FIG. 8.

The method [800] includes [810] directing light 32 at the electrical component 30. The electrical component 30 is on a substrate 33 and the light 32 is at an original intensity I_{inc}.

The method [800] further includes [820] measuring light that is reflected off of the electrical component 30. The reflected light includes undiffracted light 34 and diffracted light 35. The diffracted light 35 is at a diffracted intensity L.

The method [800] further includes [830] determining a ratio of diffracted intensity I₁ to original intensity I_{inc} and [840] utilizing the ratio to determine a geometry of the electrical component 30. As an example, [840] utilizing the ratio to determine a geometry of the electrical component 30 may include utilizing the ratio to determine (i) an undercut (not shown in FIGS. 8 and 9) of the electrical component 30; and/or (ii) a pitch, a height and a shape of the electrical component 30.

In addition, [830] directing light 32 the electrical trace 30 includes directing light 32 at (i) an angle between 15 and 75 degrees relative to an upper surface 36 of the substrate 33; and/or (ii) multiple angles relative to an upper surface 36 of the substrate 33.

In some forms, [820] measuring light that is reflected off of the electrical component 30 may include measuring light with a CCD array. It should be noted that other forms of [820] measuring light that is reflected off of the electrical component 30 are contemplated.

The methods described herein may provide non-destructive measuring of trace undercuts. Trace undercut is an important parameter to monitor during high volume manufacturing. Trace undercut is typically difficult to monitor in conventional methods because trace undercut must be checked by cross section. Thus, more frequent monitoring of trace undercuts by non-destructive measuring may improve process controls, which would enable better yields.

The methods described herein would also simultaneously allow for the detection of trace width and thickness. Trace width and thickness are also important parameters to monitor during high volume manufacturing. Trace width and thickness are currently measured with a different tool. Therefore, the methods described herein may eliminate the need for a different tool to measure trace width and thickness.

FIG. 10 is a block diagram of an electronic apparatus 1000 incorporating at least method [400], [600], [800] described herein. Electronic apparatus 1000 is merely one example of an electronic apparatus in which the methods [400], [600], [800] may be used.

Examples of an electronic apparatus 1000 include, but are not limited to, personal computers, tablet computers, mobile telephones, game devices, MP3 or other digital music players, etc. In this example, electronic apparatus 1000 comprises a data processing system that includes a system bus 1002 to couple the various components of the electronic apparatus 1000. System bus 1002 provides communications links among the various components of the electronic apparatus 1000 and may be implemented as a single bus, as a combination of busses, or in any other suitable manner.

An electronic assembly 1010 that uses any of the methods [400], [600], [800] as describe herein may be coupled to system bus 1002. The electronic assembly 1010 may include any circuit or combination of circuits. In one embodiment, the electronic assembly 1010 includes a processor 1012 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 1010 are a custom circuit, an application-specific integrated circuit (ASIC), or the like, such as, for example, one or more circuits (such as a communications circuit 1014) for use in wireless devices like mobile telephones, tablet computers, laptop computers, two-way radios, and similar electronic systems. The IC can perform any other type of function.

The electronic apparatus 1000 may also include an external memory 1020, which in turn may include one or more memory elements suitable to the particular application, such as a main memory 1022 in the form of random access memory (RAM), one or more hard drives 1024, and/or one or more drives that handle removable media 1026 such as compact disks (CD), flash memory cards, digital video disk (DVD), and the like.

The electronic apparatus 1000 may also include a display device 1016, one or more speakers 1018, and a keyboard and/or controller 1030, which can include a mouse, trackball, touch screen, voice-recognition device, or any other device that permits a system user to input information into and receive information from the electronic apparatus 1000.

To better illustrate the method and apparatuses disclosed herein, a non-limiting list of embodiments is provided herein:

Example 1 includes a method of nondestructively measuring an undercut on an electrical trace. The method includes directing light at the undercut on the electrical trace. The electrical trace is on a substrate and the light is at an original intensity. The method further includes measuring light that is reflected off of the undercut on the electrical trace. The reflected light includes undiffracted light and diffracted light. The diffracted light is at a diffracted intensity. The method further includes determining a ratio of diffracted intensity to original intensity and utilizing the ratio to determine a geometry of the undercut on the electrical trace.

Example 2 includes the method of example 1, wherein utilizing the ratio to determine a geometry of the undercut on the electrical trace includes utilizing the ratio to determine a volume of the undercut on the electrical trace.

Example 3 includes the method of any one of examples 1-2, wherein utilizing the ratio to determine a geometry of the undercut on the electrical trace includes comparing the ratio with a stored set of data.

Example 4 includes the method of any one of examples 1-3, wherein utilizing the ratio to determine a geometry of the undercut on the electrical trace includes determining the geometry by performing mathematical calculations using the ratio.

Example 5 includes the method of any one of examples 1-4, wherein directing light at the undercut on the electrical trace includes directing light at an angle between 50 and 70 degrees relative to an upper surface of the substrate.

Example 6 includes the method of any one of examples 1-5, wherein directing light at the undercut on the electrical trace includes directing light at multiple angles relative to an upper surface of the substrate.

Example 7 includes the method of any one of examples 1-6, wherein measuring light that is reflected off of the undercut on the electrical trace includes measuring light with a CCD array.

Example 8 includes a method of nondestructively measuring electrical trace geometry. The method includes directing light at an electrical trace on a substrate. The light is at an original intensity. The method further includes measuring light that is reflected off of the electrical trace. The reflected light includes undiffracted light and diffracted light. The diffracted light is at a diffracted intensity. The method further includes determining a ratio of diffracted intensity to original intensity and utilizing the ratio to determine a geometry of the electrical trace.

Example 9 includes the method of example 8, wherein utilizing the ratio to determine a geometry of the electrical trace includes determining a height and a width of the electrical trace.

Example 10 includes the method of examples 8-9, wherein utilizing the ratio to determine a geometry of the electrical trace includes determining a distance to another electrical trace.

Example 11 includes the method of any one of examples 8-10, wherein utilizing the ratio to determine a geometry of the electrical trace includes comparing the ratio with a stored set of data.

Example 12 includes the method of any one of examples 8-11, wherein directing light at an electrical trace on a substrate includes directing light at an angle between 15 and 30 degrees relative to an upper surface of the substrate.

Example 13 includes the method of any one of examples 8-12, wherein directing light at an electrical trace on a substrate includes directing light at multiple angles relative to an upper surface of the substrate.

Example 14 includes the method of any one of examples 8-13, wherein measuring light that is reflected off of the electrical trace includes measuring light with a CCD array.

Example 15 includes a method of nondestructively measuring a geometry of an electrical component on a substrate. The method includes directing light at the electrical component. The light is at an original intensity. The method further includes measuring light that is reflected off of the electrical component. The reflected light includes undiffracted light and diffracted light. The diffracted light is at a diffracted intensity. The method further includes determining a ratio of diffracted intensity to original intensity and utilizing the ratio to determine a geometry of the electrical component.

Example 16 includes the method of example 15, wherein utilizing the ratio to determine a geometry of the electrical component includes determining an undercut of the electrical component.

Example 17 includes the method of examples 15-16, wherein utilizing the ratio to determine a geometry of the electrical component includes determining a pitch, a height and a shape of the electrical component.

Example 18 includes the method of any one of examples 15-17, wherein directing light at the electrical component includes directing light at an angle between 15 and 75 degrees relative to an upper surface of the substrate.

Example 19 includes the method of any one of examples 15-18, wherein directing light at the electrical component includes directing light at multiple angles relative to an upper surface of the substrate.

Example 20 includes the method of any one of examples 15-19, wherein measuring light that is reflected off of the electrical trace includes measuring light with a CCD array.

This overview is intended to provide non-limiting examples of the present subject matter. It is not intended to provide an exclusive or exhaustive explanation. The detailed description is included to provide further information about the methods.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. In addition, the order of the methods described herein may be in any order that permits fabrication of an electrical interconnect and/or package that includes an electrical interconnect. Other embodiments can be used, such as by one of ordinary skill in the art upon reviewing the above description.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of nondestructively measuring an undercut on an electrical trace, comprising:
directing light at the undercut on the electrical trace, wherein the electrical trace is on a substrate and the light is at an original intensity;
measuring light that is reflected off of the undercut on the electrical trace, wherein the reflected light includes undiffracted light and diffracted light, wherein the diffracted light is at a diffracted intensity;
determining a ratio of diffracted intensity to original intensity; and
utilizing the ratio to determine a geometry of the undercut on the electrical trace.

2. The method of claim 1, wherein utilizing the ratio to determine a geometry of the undercut on the electrical trace includes utilizing the ratio to determine a volume of the undercut on the electrical trace.

3. The method of claim 1, wherein utilizing the ratio to determine a geometry of the undercut on the electrical trace includes comparing the ratio with a stored set of data.

4. The method of claim 1, wherein utilizing the ratio to determine a geometry of the undercut on the electrical trace includes determining the geometry by performing mathematical calculations using the ratio.

5. The method of claim 1, wherein directing light at the undercut on the electrical trace includes directing light at an angle between 50 and 70 degrees relative to an upper surface of the substrate.

6. The method of claim 1, wherein directing light at the undercut on the electrical trace includes directing light at multiple angles relative to an upper surface of the substrate.

7. The method of claim 1, wherein measuring light that is reflected off of the undercut on the electrical trace includes measuring light with a CCD array.

8. A method of nondestructively measuring electrical trace geometry, comprising:
directing light at an electrical trace on a substrate, wherein the light is at an original intensity;
measuring light that is reflected off of the electrical trace, wherein the reflected light includes undiffracted light and diffracted light, wherein the diffracted light is at a diffracted intensity;
determining a ratio of diffracted intensity to original intensity; and
utilizing the ratio to determine a geometry of the electrical trace.

9. The method of claim 8, wherein utilizing the ratio to determine a geometry of the electrical trace includes determining a height and a width of the electrical trace.

10. The method of claim 9, wherein utilizing the ratio to determine a geometry of the electrical trace includes determining a distance to another electrical trace.

11. The method of claim 8, wherein utilizing the ratio to determine a geometry of the electrical trace includes comparing the ratio with a stored set of data.

12. The method of claim 8, wherein directing light at an electrical trace on a substrate includes directing light at an angle between 15 and 30 degrees relative to an upper surface of the substrate.

13. The method of claim 8, wherein directing light at an electrical trace on a substrate includes directing light at multiple angles relative to an upper surface of the substrate.

14. The method of claim 8, wherein measuring light that is reflected off of the electrical trace includes measuring light with a CCD array.

15. A method of nondestructively measuring a geometry of an electrical component on a substrate, comprising:
directing light at the electrical component, wherein the light is at an original intensity;
measuring light that is reflected off of the electrical component, wherein the reflected light includes undiffracted light and diffracted light, wherein the diffracted light is at a diffracted intensity;
determining a ratio of diffracted intensity to original intensity; and
utilizing the ratio to determine a geometry of the electrical component.

16. The method of claim 15, wherein utilizing the ratio to determine a geometry of the electrical component includes determining an undercut of the electrical component.

17. The method of claim 15, wherein utilizing the ratio to determine a geometry of the electrical component includes determining a pitch, a height and a shape of the electrical component.

18. The method of claim 15, wherein directing light at the electrical component includes directing light at an angle between 15 and 75 degrees relative to an upper surface of the substrate.

19. The method of claim 15, wherein directing light at the electrical component includes directing light at multiple angles relative to an upper surface of the substrate.

20. The method of claim 15, wherein measuring light that is reflected off of the electrical trace includes measuring light with a CCD array.
